(19) United States
(12) Patent Application Publication
(10) Pub. No.: US 2025/0189952 A1
(43) Pub. Date: Jun. 12, 2025

(54) Method For Data Management, In Particular Of Operating Means Of A Machine Tool, And Operating Means And A Machine Tool For Implementing The Method

(71) Applicant: Reishauer AG, Wallisellen (CH)

(72) Inventors: Christian Dorig, Wallisellen (CH); Markus Von Gugelberg, Zürich (CH); Roger Keller, Oberembrach (CH)

(73) Assignee: Reishauer AG, Wallisellen (CH)

(21) Appl. No.: 18/841,065

(22) PCT Filed: Feb. 2, 2023
(86) PCT No.: PCT/EP2023/052596

§ 371 Date: Aug. 23, 2024

(30) Foreign Application Priority Data
Feb. 24, 2022 (CH) 000182/2022

(51) Int. Cl. G05B 19/418

(52) U.S. Cl. CPC G05B 19/4183; G05B 19/4187

(57) ABSTRACT

With a method for data management, in particular of operating means of a machine tool, data from operating means (23, 28, 29) of the machine tool (20) is acquired and stored, at least in respect of its identification. According to the invention, this data management takes place with a machine tool (20) for producing toothed wheels or gearwheels and/or the processing of toothed systems, wherein use is made as operating means (23, 28, 29) in particular of dressing and truing tools, clamping means, grinding tools, and/or the like, wherein, for the acquisition in particular of their identification, and preferably of further parameters, such as use data and geometry data, they are in each case equipped with at least one transponder (23′, 28′, 29′). These transponders (23′, 28′, 29′) can communicate with at least one send/read unit (30) assigned to the machine tool (20), for the cableless transfer of data signals. With this data management, the production of precisely manufactured toothed wheels can be achieved, with significantly lower fault quotas and therefore an improved quality standard, and all this with maximum service life times of the processing tools.

The invention relates to a method for data management, in particular of operating means of a machine tool, wherein the data from the operating means of the machine tool is acquired and stored at least in respect of its identification, wherein the operating means are processing tools, clamping and centring means for at least one processing tool and/or for the workpiece, this being in accordance with the preamble to claim 1, and operating means and a machine tool.

With known operating means management of machine tools, in particular for the production of toothed wheels or gear wheels or for the machining or processing of tooth systems, the parameters of the operating means, such as of tools, clamping devices, etc., are usually entered and registered by the operating personnel in the data registration system of the machine tool, individually and in accordance with use, on registration cards or the like. However, this type of registration of the parameters of the operating means lacks a central superordinated method of evaluation, and accordingly only allows for restricted access, and data cannot be collected over a lengthy period of time, or only laboriously. As well as this, only a restricted exchange takes place between the machine manufacturers and the tool manufacturers on the one hand, and, on the other, the producers of the toothed wheels used by the said manufacturers.

With machine tools which work by means of roll grinding, profile grinding, honing of toothed arrangements, roller milling, roll peeling, or the like, there is a basic precondition that the tools used for this purpose are manufactured with maximum precision, and the production costs are correspondingly high. The effort is therefore made to achieve a maximum service life for these tools, and for them always to be used to optimum effect.

The invention is therefore based on the object of further developing a method for data management of the operating means, such that, with this, the data for the operating means of a machine tool, such as, for example, the tools, clamping means, etc., can be acquired and evaluated during the production process in an automated manner, without manual entries or the like.

This object is solved according to the invention by the features of claim 1.

According to the invention, the data management of operating means with a machine tool for manufacturing toothed wheels or gearwheels and/or the machining and processing of toothed arrangements, wherein, as operating means, use is made in particular of dressing or truing tools, clamping means, grinding tools, and/or the like, which are each fitted with at least one transponder for the acquisition in particular of their identification, and preferably of further parameters, such as use and geometry data, wherein this transponder can in each case communicate with at least one of the send/read units assigned to the machine tool for the contactless reading and/or sending of data signals.

With this data management according to the invention, the production of precisely-manufactured toothed wheels can be achieved with significantly lower fault quotas, and therefore an improved standard of quality, and still with maximum service lives of the processing tools. In addition, the production times can be reduced or optimized in accordance with demand.

Very advantageously, RFID tags are used in each case in the operating means for the integrated transponders, which communicate with this send/read unit assigned to the machine tool at a frequency in the UHF wave range. This therefore allows for data stored in the transponders to be read by the send/read unit, or, conversely, for data and energy capacity to be sent from this unit to the transponder and stored in it.

In addition to this, the signal transfer between the send/read unit and the transponders takes place via at least one antenna assigned to the send/read unit and, if required, to an additional auxiliary antenna. This latter antenna is located fixed or adjustably in the machine tool in such a way that this signal transfer capacity between the send/read unit and the operating means is adequate and is therefore always guaranteed. The at least one antenna can be located separately, with a cable connection to the send/read unit, or integrated in it.

When adjusting the machine tool before the actual machining and processing with the operating means which are to be used, an automated program-controlled acquisition by the send/read unit of the data from the operating means takes place. This data is checked, assigned, visualized, stored, and/or otherwise evaluated by an evaluation unit. As a result, erroneous manipulations can be almost entirely excluded when dressing and truing before the start of the actual grinding, milling, peeling, or honing work of clamped workpieces.

After a partial or complete machining procedure of workpieces by the machine tool with the operating means used, an automated program-controlled acquisition of specific data likewise takes place, such as the processing time for determining the service life of the tools being used, which is then acquired by the send/read unit, and this data is then acquired and stored by the evaluation unit.

The invention and its further advantages are explained hereinafter on the basis of exemplary embodiments and by reference to the drawings.

The Figures show:

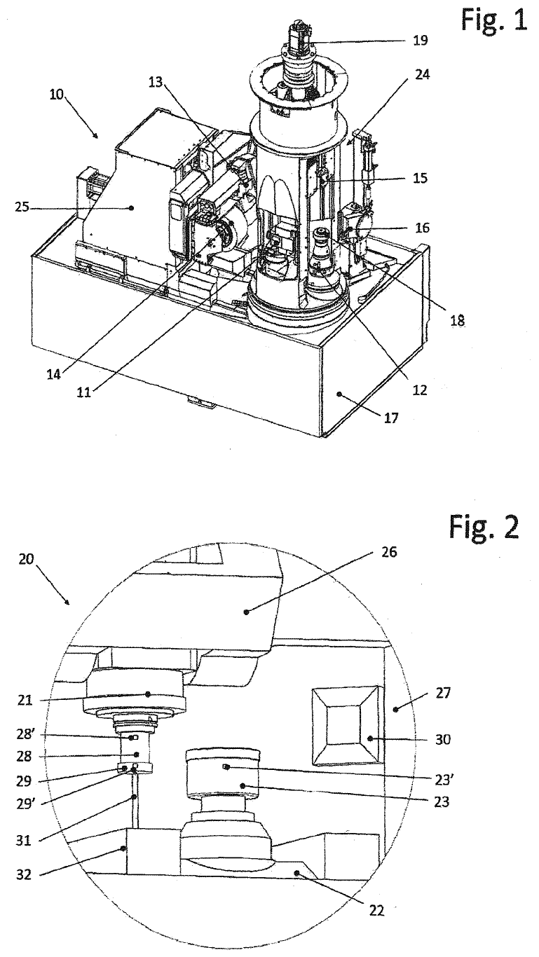

FIG. 1 is a perspective view of a machine tool according to the invention for the machining of a toothed system of a workpiece with a grinding tool; and

FIG. 2 is a schematic perspective view of a machine tool according to the invention for the production of a toothed wheel with a peeling tool.

FIG. 1 shows a machine tool 10 for the processing of toothed arrangements of a work piece 18, with a machine bed 17, a tool tower 24 mounted on this bed and rotatable about a vertical axis, a device 16 arranged next to this, with a centring probe and a tool carriage 25, guided horizontally in an adjustable manner on the machine bed 17, with a rotatably mounted processing tool 14. Provided in this portal with the tool tower 24 is a clamping means 12 of the workpiece 18, and also a dressing and truing device 11 with a dressing tool, a tailstock device 15 arranged in a height-adjustable manner above the workpiece 18 in order to centre it, and above this a motor drive 19. With this motor drive 19, the tool tower 24, with the tool table as a portal, can be rotated. Provided in addition to this are an adjustable cooling nozzle device 13, assigned to the tool 14, and further components of a clamping means and its bearings. This tool 14, configured as a grinding wheel, can be rotated about a horizontal axis, but could of course also be arranged such as to rotate about an oblique axis.

Provided as operating means for the machine tool 10 are, in particular, this processing tool 14, the clamping means 12, the dressing tool, the tailstock tip of this tailstock device 15, and the nozzle of the cooling nozzle device 13.

With the machine tool 10 represented, it is possible in a known manner for work to be carried out by continuous roll grinding, partial roll grinding, discontinuous or continuous profile grinding of workpieces, or the dressing and truing of tools.

FIG. 2 shows schematically a workpiece table 22 of a machine tool 20, with a clamping means 23 for a workpiece, not shown in any greater detail, and a tool carriage 26, preferably movable in the X and Z direction, with a bearing support 21, and a tool holder 28 for a processing tool 29. This processing tool 29, configured as a peeling tool, is rotated by a rotary drive, not shown in any greater detail, and is arranged such as to be movable up and down for roller peeling.

Provided as operating means for this machine tool 20 are, for example, the tool holder 28 and the processing tool 29 on the one hand, and, on the other, on the workpiece side, the clamping means 23.

Not all the details of these machine tools 10, 20 are explained, but only the machine components and operating means are described which are relevant to the invention.

This could equally well relate to machine tools, which operate by means of honing toothed arrangements, roller milling, or a combined production and processing of toothed wheels and gearwheels.

According to the invention, data management takes place with these machine tools 10, 20, which are designed for the production of toothed wheels or the processing of toothed arrangements of workpieces, wherein the data is acquired in particular of their operating means at least in relation to their identifications. For the purposes of this acquisition, these operating means 23, 28, 29 are in each case equipped with at least one transponder 23′, 28′, 29′, which can communicate with a send/read unit 30, assigned to the machine tool 10, 20, as is shown in FIG. 2, for the cableless transfer of data signals. Appropriate transponders and a send/read unit can be provided in analog format with the operating means of the machine tool 10, in accordance with FIG. 1, which is not shown.

This transponder 23′, 28′, 29′, preferably allocated on the outside in each case to the operating means 23, 28, 29, are very advantageously produced as RFID tags, which communicate with the send/read unit 30 assigned to the machine tool 20 at a frequency in the UHF wave range. This relates to send/read units and UHF tags as transponders which are from known manufacturers. These transponders 23′, 28′, 29′ are only shown by indication with the operating means 23, 28, 29 according to FIG. 2, but not with those according to FIG. 1, although they could be provided for in the same way.

The transponders 23′, 28′, 29′ are in each case secured on the outside of the operating means 23, 28, 29, for example by adhesive bonding. Advantageously, they can be secured in an outside receiver on the respective outer casing of the operating means 23, 28, 29, wherein they are located in each case projecting on the outer surface or flush with it. It is possible in each case for a transponder, or a plurality of transponders, to be arranged at the outer circumference and/or on a face side of a respective operating means 23, 28, 29. In order to establish fixing, or as a protective layer against impacts or coolant fluids, the transponders 23′, 28′, 29′ can have a non-conductive material, such as a resin, cast around them on the outside.

The invention is further characterized in that the signal transfer between the send/read unit 30 and the transponders 23′, 28′, 29′ takes place between an antenna assigned to the send/read unit 30 and at least one additional auxiliary antenna 31. In this situation, this auxiliary antenna 31 is located secured or adjustably in the machine tool 20 in such a way that this signal transfer is ensured between the send/read unit 30 and the operating means 23, 28, 29 at all times, or at least in specific positions of the operating means.

To the purpose, this auxiliary antenna 31 is located close to the transponders 23′, 28′, 29′, preferably without any other components coming between them. The transponders 23′, 28′, 29′ are in turn located correspondingly in the operating means 23, 28, 29 in such a way that they are aligned against the auxiliary antenna 31. The distance interval between the auxiliary antenna 31 and the transponders moves preferably in the millimetre range, in particular during the dressing of the machine tool before or after a machining process, wherein the data from the operating means 23, 28, 29 is read, and then sent via the send/read unit 30 to an evaluation unit for evaluation and storage.

Advantageously, the send/read unit 30 is arranged with its antenna laterally in the processing zone in the vicinity of the operating means 23, 28, 29, and the auxiliary antenna 31, as indicated above, is arranged directly next to the transponders 23′, 28′, 29′, in each case at a stationary part 27, 32 of the machine tool. These placements of the send/read unit and the auxiliary antenna can be varied depending on the machine type. For example, the at least one antenna of the send/read unit can be arranged behind the processing space or on the cover side. Likewise, the auxiliary antenna can be positioned in such a way that it can be moved towards and away from a respective transponder, or that the operating means can be moved, with the transponder, towards or away from the auxiliary antenna arranged in a fixed position.

With this auxiliary antenna 31, among other factors, the range of the signal transfer capacity of the transponders can be increased. This is necessary if, due to the geometric arrangements of the operating means, or due to the environmental conditions in the machine tool, a transponder cannot be read satisfactorily. This geometric arrangement of the operating means has the further effect that they function as an antenna extension for the transponders. Longitudinal geometries of the operating means are better suited for the range of the signal transfer capacity of the transponders. However, because the external geometries with many operating means cannot be changed, within the framework of the invention these auxiliary antennae are used.

From the evaluation unit, data can be forwarded to the central control unit of the machine tool 20, and by this unit is taken up into at least one databank in a program-controlled manner, checked, and bundled for the machining process. By means of a computer program, these forwarded data signals can be checked, assigned, stored, visualized, and/or processed in other ways.

In addition, the data can be exchanged between the machine tools 10, 20 which are in operation, and forwarded via a network to external locations, such as preferably to the machine and tool manufacturers, where this data is evaluated and the operating means 23, 28, 29 are adjusted and optimized, and therefore the quality assurance of production can be improved. Conversely, this evaluated data can be transferred from this external location to the respective machine tool at the producers' location. The producer of the toothed wheels or gearwheels can optionally likewise have access to this data.

This auxiliary antenna 31 is formed from a rod, a flexible longitudinal element such as a spring or a wire, or another suitable form. It could also consist of several arms connected to one another by jointed connections, in the form of a telescope. It would of course also be possible for several auxiliary antennae to be provided, preferably each for one operating means, at different specific positions in or at the machine tool, which would be able to communicate likewise with several antennae in each case of one or more send/read units.

Preferably, when dressing the machine tool 20 for processing with the necessary processing means 23, 28, 29, an automated program-controlled processing takes place of the data signals transferred from the transponders 23′, 28′, 29′ to the send/read unit 30 and to the evaluation unit, which are then correspondingly checked, assigned, visualized, stored, and otherwise evaluated and/or forwarded. This data can of course also be called up manually and viewed. As well as this, they should advantageously also be able, at any time, to be manually supplemented, corrected, and/or processed, whether directly at the evaluation unit on the machine or also externally via the network.

After a partial or total processing procedure by the machine tool 20, with the identified operating means 23, 28, 29, it is then possible in turn for an automated program-controlled processing of specific data to be carried out, such as the processing time for determining the service life of the tools 29 being used. From the evaluation unit, data can be forwarded to the central control unit of the machine tool 20, and then, program-controlled, can be stored by this and bundled for further processing processes.

During the acquisition by the transponders 23′, 28′, 29′ assigned to the operating means 23, 28, 29, at the identification procedure at least the article numbers and serial numbers of the operating means are communicated, and, if appropriate, further data related to them, such as the index, or the repair or review numbers. In addition to this, the use and geometry data of the operating means 23, 28, 29 can be entered in the respective transponder 23′, 28′, 29′, or called up from it. As useful data, in particular effectively determined service lives or limit values for service lives can be determined, which can then be set by the producers of the toothed wheel as required. The geometry data relates to reference data which is used, for example, for designing the tools, and which is specified as the same for all articles with the same article number, as well as actual data, which is measured and retained after production.

With a peeling tool as the operating means 29, the operating time length and the number of cuts respectively during the processing of a workpiece can be determined and stored, for example, on the basis of the lifting movements per time unit and the duration of use, as well as the number of workpieces processed with the one peeling tool 29 by means of appropriate measuring means and by way of the send/read unit 30 in the transponder itself.

With the processing tools 14 as grinding wheels, the important identification as to whether this involves a CBN grinding worm, a single profile wheel, a set profile wheel, a profile wheel set, or the like, can be acquired automatically by the machine tool, and can then be taken into account in a simple and reliable manner when dressing the tool, without the possibility of incorrect inputs such as can occur with manual input.

With dressing and truing tools as the operating means, specific data for use, such as the number of dressing cycles, dressing volume, dressing length, and other factors, can be calculated, written into the transponder and stored in it.

With certain machine tools, it is possible for provision to be made on the workpiece side, in addition to the tailstock tip 15, for gripper chucks or base grippers of the clamping means, as well as various elements referred to as receivers, as operating means with transponders. These relate to holding and retaining devices on which the workpiece can be laid and secured, or for spraying with grinding oil, a station for reading DMC codes which are applied to the workpiece, or deposit areas for workpieces which are intended to be measured or are unsatisfactory.

Additionally, within the framework of the invention it is also possible for tool or workpiece magazines, loading modules for the automatic loading of workpieces, or additional devices for measuring, truing, or other work activities to be equipped with operating means according to the invention with transponders and send/read units, which, for example, communicate with the central control units of the machine tool or with separate evaluation units. This may also involve devices for supplying grinding oil.

The invention has been adequately described by way of the exemplary embodiments presented heretofore. Further variants could also be demonstrated, however.

In principle, it would be possible, instead of UHF tags, depending on the requirement and the provision of auxiliary antennae, for LF or HF tags to be used, which likewise provide an unambiguous identification in comparison with UHF tags but over a shorter range, in the millimetre range, and conversely have more memory storage space.

An alternative to UHF tags would be the use of SHF tags (Super High Frequency).

In principle it would be possible for the identification to be made by way of a UHF transponder and for the further data acquisition and storage to be carried out on a second HF transponder, which is located on the operating means. As an alternative, this further data could be provided on data carriers, DMC code or RFID transponders (card, tag, or similar) at different frequencies. It would also be possible for this further data present on the operating means to be loaded onto the machine tool from a databank in the vicinity of the machine tool, at the location of the toothed wheel producers, or in a cloud.

If the transponder has sufficient storage capacity, all the data could be stored on it, and read or called up from there. This would allow for the system to be operated without an additional databank. With only limited storage space on the transponder, only a part of the operating means data could be stored on it, such as, with processing tools, the identification data and selected effectively performed operating times. The other data (e.g. geometry data, limit values) is acquired either via a network or another data carrier. This can be carried out from the network between the machines of the toothed wheel manufacturer and/or of the machine tool manufacturer.

With regard to the toothed wheels, it is possible, as well as conventional configurations, for toothed wheel segments, worm wheels, or the like to be processed.

In principle, it would also be possible for an adequate transfer capacity to be achieved even without auxiliary antennae, for example with smaller machine tools. Likewise, the send/read unit and the evaluation unit could also be located as separate devices on or next to the machine tool.

1. Method for data management, in particular of operating means of a machine tool, wherein the data from the operating means (23, 28, 29) of the machine tool (10, 20) is acquired and stored at least in respect of its identification, wherein the operating means (23, 28, 29) are, for example, processing tools, clamping and centring means for holding these tools and workpieces, characterized in that the data management takes place with a machine tool (10, 20) for the manufacture of toothed wheels or gearwheels, wherein use is made as operating means (23, 28, 29) of, in particular, dressing and truing tools, clamping means, grinding tools and/or similar devices, which for the purpose of acquisition, in particular of their identification and preferably also of further parameters, such as usage and geometry data, are in each case equipped with at least one transponder (23′, 28′, 29′), wherein these transponders (23′, 28′, 29′) can communicate with at least one send/read unit (30) assigned to the machine tool (10, 20) for the cableless transfer of data signals.

2. Method according to claim 1, characterized in that, preferably at the dressing of the machine tool (10, 20) for processing with the operating means which are to be used, an automated program-controlled acquisition takes place of the data signals transferred between the transponders (23′, 28′, 29′) and the send/read unit (30), and this data is checked, assigned, visualized, stored, and/or otherwise evaluated by an evaluation unit.

3. Method according to claim 1, wherein after a partial or total processing procedure by the machine tool with the operating means is identified, an automated program-controlled acquisition takes place of specific data, such as the operating time for determining the service life time of the tools being used.

4. Method according to claim 2, further comprising integrating the evaluation unit connected to the send/read unit in the central control unit in a switch cabinet of the machine tool, and the data can be exchanged or processed between these devices by means of a computer program.

5. Method according to claim 1, wherein the data is transferred via a network to at least one external location or, conversely, is transferred from this location to the respective machine tool, such as, to or from the machine manufacturer and tool manufacturer as the external location, at which this data can be evaluated, and the operating means can be adjusted and optimized.

6. Method according to claim 1, wherein the transponders integrated in the operating means as RFID tags communicate with this send/read unit at a frequency in the UHF wave range.

7. Method according to claim 1, wherein the signal transfer between the send/read unit and the transponders takes place via an antenna assigned to the send/read unit and at least one additional auxiliary antenna, wherein this auxiliary antenna is located in a fixed or adjustable manner in the machine tool in such a way that this signal transfer between the send/read unit and the operating means is guaranteed.

8. Operating means of a machine tool for implementing the method according to claim 1, wherein the operating means relate in particular to dressing and truing tools and clamping means, but also to grinding, milling, peeling, and honing tools, clamping and centring means, grinding oil nozzles of the machine tool for the manufacture of toothed wheels and/or the processing of toothed systems, wherein these operating means are in particular equipped on their respective outer sides with at least one transponder, in such a way that these can communicate with this send/read unit assigned to the machine tool via at least one antenna.

9. Operating means according to claim 8, characterized in that the respective transponders (23′, 28′, 29′) are secured in a receiver aperture on the outer side of an operating means (23, 28, 29), such as, for example, by resin, and are located projecting on the outer surface or flush with it.

10. Operating means according to claim 8, wherein the transponders integrated in each case in the operating means are produced as RFID tags with a working frequency in the UHF or SHF wave range.

11. Machine tool for implementing the method according to claim 1, which is equipped with operating means, such as, for example, processing tools, and clamping and centring means for holding the tools and workpieces, characterized in that the machine tool is configured for the manufacture of toothed wheels and/or the processing of toothed systems, wherein, as operating means, use can be made in particular of dressing and truing tools, clamping means, grinding tools, and/or similar devices, which in each case are equipped with at least one transponder for the acquisition in at least one databank in particular of their identification and other parameters, such as use data and geometry data, wherein at least one send/read unit is integrated, which is operationally connected on one side to the transponders for the cableless transfer of data signals, and on the other side to an evaluation unit in the central control unit of the machine tool, by means of which the forwarded data signals are checked, assigned, stored, visualized, and/or otherwise evaluated by a computer program.

12. Machine tool according to claim 11, characterized in that in each case at least one antenna, assigned to the send/read unit (30), and an additional auxiliary antenna (31) are present in the machine tool (10, 20), wherein this auxiliary antenna (31) is located in a fixed or adjustable manner in the machine tool (10, 20) in such a way that this signal transfer between the operating means and the send/read unit is assured.

13. Machine tool according to claim 12, characterized in that the auxiliary antenna (31) is formed from a rod, a flexible longitudinal element such as a spring or a wire, or another suitable form, and is positioned in the vicinity of the transponders (23′, 28′, 29′).

14. Machine tool according to claim 11, further comprising arranging the send/read unit with its antenna in the processing zone in the vicinity of the operating means, and the auxiliary antenna is arranged directly next to the transponders, in each case at a stationary part of the machine tool.

15. Machine tool according to claim 11, wherein the auxiliary antenna is positioned in such a way it can be moved towards a respective transponder or away from it respectively, and/or that the operating means with the transponder can be moved towards the fixed auxiliary antenna or away from it.

16. Machine tool according to claim 11, wherein by means of the machine tool, configured for the manufacture of toothed wheels and/or the processing of toothed systems, continuous roller grinding, partial roller grinding, discontinuous or continuous profile grinding, honing of toothed systems, roll milling, and/or roller peeling can be carried out.
